(19) United States
(12) Patent Application Publication
(10) Pub. No.: US 2021/0305910 A1
(43) Pub. Date: Sep. 30, 2021

(54) THYRISTOR RECTIFIER WITH IMPROVED SURGE CHARACTERISTICS AND ELECTRIC MOTOR DRIVE WITH A CORRESPONDING THYRISTOR RECTIFIER

(71) Applicant: Danfoss Power Electronics A/S, Gråsten (DK)

(72) Inventors: Finn Borup, Sydals (DK); Henning Markus Mortensen, Skærbæk (DK)

(21) Appl. No.: 17/213,758

(22) Filed: Mar. 26, 2021

(30) Foreign Application Priority Data
Mar. 27, 2020 (DE) 102020108591.5

(51) Int. Cl. H02M 7/155; H02P 27/04

(52) U.S. Cl. CPC H02M 7/155; H02P 27/04

(57) ABSTRACT

The present invention relates to AC-DC conversion in power electronics. In particular, the present invention is directed at a thyristor rectifier, which may be employed in an electric motor drive. The rectifier includes three thyristors and three diodes, wherein the thyristors are connected to a positive rectifier output and the three diodes are connected to a negative rectifier output. The present invention also relates to an electric motor drive comprising a corresponding thyristor rectifier. In general, the present invention may be used in a frequency converter for an electric motor drive, but it can also be used in non-drive application.

### CROSS-REFERENCE TO RELATED APPLICATION

This application claims foreign priority benefits under 35 U.S.C. § 119 to German Patent Application No. 102020108591.5 filed on Mar. 27, 2020, the content of which is hereby incorporated by reference in its entirety.

### TECHNICAL FIELD

The present invention relates to AC-DC conversion in power electronics. In particular, the present invention is directed at a thyristor rectifier, which may be employed in an electric motor drive. The rectifier comprises three thyristors and three diodes, wherein the thyristors are connected to a positive rectifier output and the three diodes are connected to a negative rectifier output. The present invention also relates to an electric motor drive comprising a corresponding thyristor rectifier. In general, the present invention may be used in a frequency converter for an electric motor drive, but it can also be used in non-drive applications.

### BACKGROUND

Thyristor rectifiers or silicon-controlled rectifiers are used at certain power levels in AC-DC conversion applications. Thyristors have a natural weakness, as their di/dt capability is very limited at the start of the conduction period. This has proven to be a problem in field applications, not only during lab testing.

The problem of presently implemented mitigations is that they do not provide protection to the rectifier in all relevant situations. For example, known solutions stop the triggering signal to the thyristor if an overvoltage is detected. However, this does not provide full protection as the triggering might have been initiated right at the moment of the overvoltage (surge) taking place. In this case, it is too late to remove the triggering signal, leaving a time slot where the thyristor is unprotected.

### SUMMARY

The goal of the present invention is to provide an improved thyristor rectifier, which overcomes the above-mentioned problems. This goal is achieved by means of a thyristor rectifier according to claim 1 and an electric motor drive comprising a corresponding thyristor rectifier according to claim 10. Preferable embodiments of the invention are subject to the dependent claims.

According to the invention, a thyristor rectifier is provided, which may be employed in an electric motor drive. The thyristor rectifier typically comprises three thyristors and three diodes. The thyristors are directly connected to a positive rectifier output and the three diodes are directly connected to a negative rectifier output. The thyristor rectifier comprises an impedance and a capacitor arranged in series to each other, wherein the impedance and the capacitor connect the positive rectifier output to the negative rectifier output and wherein the impedance is a NTC-resistor.

The thyristor rectifier according to the present invention limits the current during thyristor turn-on using an impedance. In the present invention, the impedance does not create problems during other operating scenarios of the thyristor rectifier.

The present invention therefore provides a simple and cheap improvement, which can be used on top of existing mitigation methods. The intention of the invention is not to replace current protective measures of thyristor rectifiers, but to add another protective measure to already present ones, thereby improving the robustness level of the thyristor rectifier and its associated systems.

By using a NTC resistor, surge protection improvement is ensured, while at the same time rectifier protection is ensured during a ground fault condition on e.g. a motor cable when utilizing IT grid supply. Such a fault can create high voltage peaks across the rectifier components, exceeding their reverse blocking voltage capabilities. These peaks can be handled by voltage limiting devices like varistors (MOV's), but they only provide very short-term protection, as they otherwise will overheat. The normal solution known from the art is to add capacitors across the rectifier. However, these capacitors provide a current path, which can damage the thyristors during a surge. By using a NTC in series with the capacitor, or a plurality of capacitors, surge robustness is improved during normal operation and additionally, motor cable fault capability is maintained, as the MOV's only have to take care of the rectifier protection until the NTC heats up.

In a preferred embodiment of the invention, the impedance is directly connected to the negative rectifier output. A direct connection in the present invention's sense means that no other electric components are provided between the impedance on the one side, and the negative rectifier output on the other side, except for an electric connection i.e. a conductor portion. The same definition may apply to other direct connections mentioned in this application.

In a further preferred embodiment of the invention, the capacitor is directly connected to the positive rectifier output. The side of the capacitor connected to the positive rectifier output may be opposite to the side of the capacitor connected to the impedance and/or the fuse.

In a further preferred embodiment of the invention, a circuit portion comprising the impedance and the capacitor is arranged in parallel to one circuit portion comprising at least a second impedance, said second impedance connecting the positive rectifier output to the negative rectifier output. The second impedance may comprise two or more impedances arranged in series to each other.

In a further preferred embodiment of the invention, the thyristors are directly connected to a positive rectifier output and the three diodes are directly connected to a negative rectifier output.

The present invention is also directed at an electric motor drive comprising a thyristor rectifier according to any of claims 1 to 9.

### BRIEF DESCRIPTION OF THE DRAWING

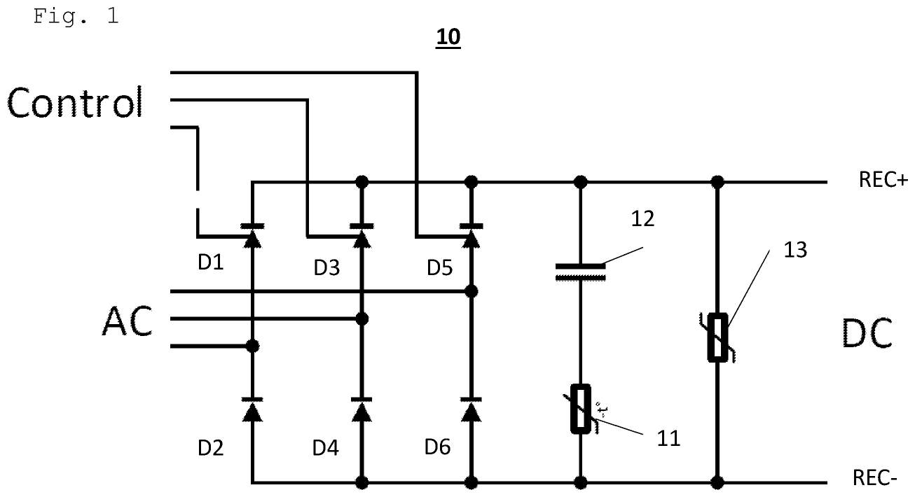

Further details and advantages of the invention are described with reference to the embodiment shown in FIG. 1.

### DETAILED DESCRIPTION

FIG. 1 shows a schematic view of a thyristor rectifier 10. The thyristor rectifier 10 may be a part of an electric motor drive. The thyristor rectifier 10 comprises three thyristors D1, D3, D5 and three diodes D2, D4, D6, wherein the thyristors D1, D3, D5 are connected to a positive rectifier output REC+ and the three diodes D2, D4, D6 are connected to a negative rectifier output REC−. According to the invention, the thyristor rectifier 10 comprises an impedance 11 and a capacitor 12 arranged in series to each other, wherein the capacitor 12 connects to the positive rectifier output REC+ and the impedance 11 connects to the negative rectifier output REC− and wherein the impedance is a NTC-resistor.

The circuit portion comprising the impedance 11 and the capacitor 12 is arranged in parallel to one circuit portion comprising at least a second impedances 13, said second impedances 13 connecting the positive rectifier output REC+ to the negative rectifier output REC−. In addition, the thyristors D1, D3, D5 are directly connected to the positive rectifier output REC+ and the three diodes D2, D4, D6 are directly connected to the negative rectifier output REC−.

Although not shown in FIG. 1, the presently described thyristor rectifier may be part of an electric motor drive.

The invention is not limited to one of the above-described embodiments, but can be modified in many ways.

All of the features and advantages arising from the claims, the description and the drawings, including constructive details, spatial arrangements and procedural steps, can be essential to the invention both individually and in the most varied of combinations.

What is claimed is:

1. A thyristor rectifier, in particular for an electric motor drive, comprising three thyristors and three diodes, wherein the thyristors are connected to a positive rectifier output and the three diodes are connected to a negative rectifier output, wherein the thyristor rectifier comprises an impedance and a capacitor arranged in series to each other, wherein the capacitor 12 connects to the positive rectifier output and the impedance 11 connects to the negative rectifier output and wherein the impedance is a NTC-resistor.

2. The thyristor rectifier according to claim 1, wherein the impedance is directly connected to the negative rectifier output.

3. The thyristor rectifier according to claim 1, wherein the capacitor is directly connected to the positive rectifier output.

4. The thyristor rectifier according to claim 1, wherein a circuit portion comprising the impedance and the capacitor is arranged in parallel to one circuit portion comprising at least a second impedance, said second impedance connecting the positive rectifier output to the negative rectifier output.

5. The thyristor rectifier according to claim 1, wherein the thyristors are directly connected to a positive rectifier output and the three diodes are directly connected to a negative rectifier output.

6. An electric motor drive comprising a thyristor rectifier according to claim 1.

7. The thyristor rectifier according to claim 2, wherein the capacitor is directly connected to the positive rectifier output.

8. The thyristor rectifier according to claim 2, wherein a circuit portion comprising the impedance and the capacitor is arranged in parallel to one circuit portion comprising at least a second impedance, said second impedance connecting the positive rectifier output to the negative rectifier output.

9. The thyristor rectifier according to claim 3, wherein a circuit portion comprising the impedance and the capacitor is arranged in parallel to one circuit portion comprising at least a second impedance, said second impedance connecting the positive rectifier output to the negative rectifier output.

10. The thyristor rectifier according to claim 2, wherein the thyristors are directly connected to a positive rectifier output and the three diodes are directly connected to a negative rectifier output.

11. The thyristor rectifier according to claim 3, wherein the thyristors are directly connected to a positive rectifier output and the three diodes are directly connected to a negative rectifier output.

12. The thyristor rectifier according to claim 4, wherein the thyristors are directly connected to a positive rectifier output and the three diodes are directly connected to a negative rectifier output.

13. An electric motor drive comprising a thyristor rectifier according to claim 2.

14. An electric motor drive comprising a thyristor rectifier according to claim 3.

15. An electric motor drive comprising a thyristor rectifier according to claim 4.

16. An electric motor drive comprising a thyristor rectifier according to claim 5.
